(19) United States
(12) Patent Application Publication
(10) Pub. No.: US 2024/0098410 A1
(43) Pub. Date: Mar. 21, 2024

(54) ELECTRO-ACOUSTIC TRANSDUCER

(71) Applicant: AMS SENSORS SINGAPORE PTE. LTD., Singapore (SG)

(72) Inventors: Laurent NEVOU, Wadenswil (CH); Jens GEIGER, Eindhoven (NL); Goran STOJANOVIC, Eindhoven (NL); Ferran SUAREZ, Rüschlikon (CH)

(21) Appl. No.: 18/277,189

(22) PCT Filed: Feb. 7, 2022
(86) PCT No.: PCT/SG2022/050057

§ 371 Date: Aug. 14, 2023

Related U.S. Application Data
(60) Provisional application No. 63/149,480, filed on Feb. 15, 2021.

(51) Int. Cl. H04R 3/00; G01B 9/02; H04R 7/04; H04R 9/06; H04R 29/00

(52) U.S. Cl. CPC H04R 3/007; G01B 9/02092; H04R 7/04; H04R 9/06; H04R 29/001; G02B 27/108

(57) ABSTRACT

An electro-acoustic transducer includes a membrane and at least one laser. The at least one laser is configured to emit radiation toward the membrane such that radiation emitted by the at least one laser is reflected from the membrane back toward the at least one laser to produce a self-mixing interference effect corresponding to an excursion or velocity of the membrane.

### FIELD OF DISCLOSURE

The present disclosure relates to electro-acoustic transducers, and in particular to loudspeakers for use in electronic devices such as smartphones, tablet computers, wearables, games systems and the like.

### BACKGROUND

Many electronic devices, such as consumer electronic devices, exhibit rich and highly integrated feature sets consisting of various sensors, transducers, user interfaces, displays and the like. For example, personal electronic devices such as smartphones, tablet computers, wearables, games systems and the like, may comprise one or more electro-acoustic transducers, such as microphones and loudspeakers.

Designers and manufacturers of such electronic devices, and in particular smartphones, may be faced with seemingly conflicting requirements. While integration of a rich and high-quality feature set may be essential to provide a device meeting commercial and technical requirements, a recent industry trend is towards miniaturization of such devices. That is, an industry trend is to provide a high degree of functionality in a generally small space.

Provision of electro-acoustic transducers of sufficient quality for use in the electronic devices may be particularly problematic. For example, it is known that loud, high-fidelity sound may be easily achievable with relatively large loudspeakers. However, within the relatively small confines of an available space within the housing of a smartphone, degrees of freedom to design and implement a loudspeaker capable of emitting high-fidelity audio may be severely constrained. A thickness of a smartphone may be particularly limited. In some instances, a MEMS (Micro-Electro-Mechanical Systems) micro-speaker may be implemented. While such speakers may be generally small, they are still subject to constraints of limited available space.

Furthermore, as electro-acoustic transducers are reduced in size, a high degree of control over the performance and functionality of the electro-acoustic transducers may be required. Such control may be necessary to achieve sufficient sound quality and/or to protect the device from damage. For example, over-excursion and/or prolonged excursion of a membrane of a loudspeaker may damage the loudspeaker, thereby potentially reducing audio performance. In some instances, over excursion of a membrane may bring the membrane into contact with a solid housing of the electronic device, potentially introducing unwanted audio artefacts or distortion and/or damaging the loudspeaker by deforming the membrane or otherwise.

It is therefore desirable to provide an electro-acoustic transducer that is sufficiently small for integration into personal electronic devices such as smartphones, tablet computers, wearables, games systems and the like, yet is also capable of meeting the performance and functionality requirements of such applications. Furthermore, it is preferable that such an electro-acoustic transducer is relatively low-cost, and can be readily manufactured using existing manufacturing techniques.

It is therefore an aim of at least one embodiment of at least one aspect of the present disclosure to obviate or at least mitigate at least one of the above identified shortcomings of the prior art.

### SUMMARY

The present disclosure is in the field of electro-acoustic transducers, and in particular to loudspeakers for use in electronic devices such as smartphones, tablet computers, wearables, games systems and the like.

According to a first aspect of the disclosure, there is provided an electro-acoustic transducer comprising a membrane and at least one laser. The at least one laser is configured to emit radiation toward the membrane, such that radiation emitted by the at least one laser is reflected from the membrane back toward the at least one laser to produce a self-mixing interference effect corresponding to an excursion or velocity of the membrane.

Advantageously, use of self-mixing interference to measure an excursion or velocity of the membrane may provide extremely precise results.

Furthermore, use of self-mixing interference may enable absolute distance measurements, thereby facilitating gauging and providing a more reliable operation of the electro-acoustic transducer.

Advantageously, use of self-mixing interference may enable direct measurement of velocities of the membrane, wherein such velocities may correspond to acoustic frequencies produced or sensed by the electro-acoustic transducer, thereby also facilitating gauging and providing a more reliable operation. This is in contrast to systems that may be required to determine the distance to the membrane at a plurality of different times, e.g. perform multiple different measurements, and then calculate the velocity therefrom.

Advantageously, use of self-mixing interference may enable implementation of a particularly small and compact means for sensing of an excursion or velocity of the membrane, in particular when a radiation source such as a vertical cavity surface emitting laser (VCSEL) is used, as described below in more detail.

Advantageously, self-mixing interference may be relatively insensitive to crosstalk for at least slightly different wavelengths. Such crosstalk may arise from the use of a plurality of different sensors and/or lasers.

Advantageously, self-mixing interference may be relatively insensitive to variations in an intensity of detected radiation, e.g. the amount of radiation returning into a cavity of the laser to provide produce the self-mixing interference effect. For example, in use an intensity of radiation may vary considerably, in particular in the case of relatively reflective membranes. Furthermore, an amount of radiation received by the laser may strongly depend upon a tilt or deformation of the membrane. Such effects may render alternative distance and/or velocity measurement techniques unfeasible, whereas measurements based on using a self-mixing interference effect as described above may provide high quality and precise results that are largely independent of the intensity of incident radiation.

The above-described self-mixing interference effects operate as follows. In use, radiation emitted from the laser may be reflected from the membrane back into the laser to produce a self-mixing effect. Interference between an internal optical field of the laser and the radiation reflected from the membrane may occur within the laser cavity to produce a detectable self-mixing interference effect, wherein the self-mixing effect may be modulated by vibrations of the membrane.

For example, if the membrane is moving, e.g. vibrating, relative to the laser, then radiation reflected by the membrane may be characterized by a frequency different from the frequency of the radiation illuminating the membrane, due to the Doppler effect. Interference between the emitted and reflected radiation within the cavity of the laser may after a behavior of the laser, and in particular may affect parameters such as an amplitude and/or frequency of radiation emitted by the laser and/or a gain of the laser.

In some examples, a fluctuation of these parameters may be characterized by a frequency corresponding to a difference between the frequencies of emitted and reflected radiation. This difference may be proportional to a velocity of the membrane.

That is, said self-mixing effect may induce variations in the behavior of the laser and thus cause detectable variations in an amplitude and/or frequency of radiation emitted by the laser, which may be optically detected as described below. Furthermore, said self-mixing effect may cause detectable variations in electrical characteristics of the laser. For example, the self-mixing effect may induce variations in a junction voltage of the laser, which may be electrically detected, as described below.

As such, characteristics of radiation emitted by the laser and/or an electrical behavior of the laser may be modulated by, and thus used to determine, an excursion and/or velocity of the membrane.

The electro-acoustic transducer may comprise a beam-splitter configured to direct a portion of radiation emitted by the at least one laser to a photodetector, for optically sensing the self-mixing interference effect.

The electro-acoustic transducer may comprise the at least one photodetector.

A mirror of a resonator in the at least one laser may be partially transparent to enable radiation emitted by the at least one laser to be incident on a photodetector, for optically sensing the self-mixing interference effect. For example, laser may be stacked on a photodetector, wherein a mirror of the laser adjacent a photosensitive surface of the photodetector is at least partially transparent, as described in more detail below.

The electro-acoustic transducer may comprise circuitry configured to drive the at least one laser with a constant current, and to measure a change in a junction voltage of the at least one laser corresponding to the self-mixing interference effect.

The electro-acoustic transducer may comprise circuitry configured to drive the at least one laser with a constant junction voltage, and to measure a change in current through the at least one laser corresponding to the self-mixing interference effect.

The electro-acoustic transducer may be configured as a loudspeaker.

In some embodiments, the electro-acoustic transducer may be configured as a microphone.

The at least one laser may comprise a vertical cavity surface emitting laser (VCSEL).

The VCSEL may be configured for emission of infrared radiation and/or radiation in the visible light range. The VCSEL may be a top-emitting VCSEL, comprising one or more contacts also formed on a top surface of the VCSEL. In some embodiments, the VCSEL may be a bottom side emitting VCSEL.

The membrane may comprise a sheet or film. The membrane may comprise a thermoplastic foil. The membrane may comprise a plurality of layers. The membrane may form a diaphragm. In some embodiments, the membrane may comprise a stretched film provided under tension. The membrane may have a thickness in the region of 100 micrometers.

The term excursion corresponds to a displacement of the membrane, e.g. a displacement from a resting position.

The electro-acoustic transducer may comprise a substrate. The substrate may be a printed circuit board. The at least one laser may be coupled to the substrate.

The at least one laser may be coupled to the substrate by soldering, or by means of a conductive connector, or the like.

The electro-acoustic transducer may comprise a magnet. The substrate may be provided between the magnet and the membrane.

The substrate may be disposed between the magnet and the membrane.

The magnet may comprise at least one recess for receiving the at least one laser.

The magnet may comprise at least one recess for receiving at least one component coupled to the substrate.

Advantageously, a size, and in particular a thickness, of the electro-acoustic transducer may be minimized by providing one or more recesses in the magnet to house components, such as the at least one laser, that may protrude from a surface of the substrate.

The membrane may be disposed between the magnet and the substrate. The substrate may be coupled to a housing of the electro-acoustic transducer.

In such embodiments, the housing may comprise one or more recesses for receiving the at least one laser, or other components, that may protrude from a surface of the substrate, thereby advantageously minimizing a size, and in particular a thickness, of the electro-acoustic transducer.

At least a portion of the substrate may be transparent to radiation emitted by the at least one laser. The at least one laser may be configured to emit radiation through the portion and towards the membrane.

For example, in the portion of the substrate disposed between the membrane and the at least one laser, any metal layers of the substrate may have apertures formed to enable propagation of radiation through the substrate.

The substrate may be a flex printed circuit board.

The electro-acoustic transducer may comprise a further substrate coupled to the flex-printed circuit board such that the flex-printed circuit board is disposed between the further substrate and the magnet. The further substrate may be rigid relative to the flex-printed circuit board. The further substrate may be a planar substrate.

The magnet may comprise at least one recess for receiving at least one component coupled to the substrate.

The electro-acoustic transducer may comprise a coil coupled to the membrane and configured for movement relative to the magnet.

The coil may be coupled directly to the membrane. The coil may be provided on a bobbin, e.g. wound around a bobbin, which is attached to the membrane.

In some embodiments, the membrane may be substantially flat in an initial, non-deformed state, e.g. where no electrical signal is applied to the coil. In some embodiments, the membrane may be curved, or conical.

The magnet may be a permanent magnet, for example a Neodymium magnet.

The coil may comprise a metallic material, e.g. copper, gold, or the like.

A conductive element may extend through an aperture in the magnet to provide an electrical connection to the substrate.

The conductive element and the substrate may be provided as a unitary member.

Advantageously, by disposing the substrate between the magnet and the membrane, a distance between the at least one laser and the membrane may be minimized, thus potentially improving a signal-to-noise ratio of measurement the self-mixing interference effect, either directly from the at least one laser or using another radiation-sensitive device, when the at least one laser is used in membrane excursion or velocity sensing applications.

Furthermore, by providing the conductive element extending through an aperture in the magnet to provide an electrical connection to the substrate, substantial space may be saved by mitigating a requirement to find an alternative conductive path to the substrate, or by mitigating a requirement to locate the substrate at a different location within the electro-acoustic transducer.

The conductive element may extend through an aperture in a first side of the magnet facing the membrane to a second side of the magnet facing away from the membrane.

The aperture may extend through a central portion of the magnet.

The at least one laser may be disposed at an opposite side of the substrate to the membrane.

Advantageously, by disposing the at least one laser on an opposite side of the substrate to the membrane, the electro-acoustic transducer may be effectively miniaturized. That is, an assembled electro-acoustic transducer having the at least one laser disposed on an opposite side of the substrate to the membrane may be smaller, and in particular thinner, than an assembled electro-acoustic transducer having the at least one laser disposed between the substrate to the membrane.

Furthermore, by disposing the at least one laser on an opposite side of the substrate to the membrane, functionality such as membrane excursion sensing may be more easily implemented without substantially increasing an overall size of the electro-acoustic transducer, as described in more detail below.

In some embodiments, the membrane may comprise a reflector or reflective coating. The reflector or reflective coating may be for reflecting radiation emitted by the at least one laser, e.g. by the laser to produce a self-mixing interference effect as described above.

The reflector may be a mirror. In some embodiments the reflector may be disposed on a surface of the membrane that is opposing the radiation-emitting surface of the laser.

In some embodiments the reflector may be disposed on an outer surface of the membrane, e.g. an opposite surface of the membrane to the surface of the membrane that is opposing the radiation-emitting surface of the laser. In such embodiments, the membrane may be substantially transparent to radiation emitted by the at least one laser.

In some embodiments, the reflector may be embedded within the membrane. For example, in some embodiments the reflector may be formed as an integral component of the membrane.

In some embodiments, the reflector may be disposed between layers of the membrane.

In some embodiments, the reflector or reflective coating may comprise gold. In some embodiments the reflector or reflective coating may comprise aluminum.

The substrate may comprise at least one aperture for radiation from the at least one laser to propagate through the substrate.

That is, the at least one laser may be coupled to, e.g. mounted on, the substrate such that a radiation-emitting surface of the at least one laser is directed toward the substrate, and wherein the aperture is aligned with the radiation-emitting surface. As such, radiation emitted from the radiation-emitting surface of the at least one laser may propagate through the aperture towards the membrane.

The at least one aperture may comprise an un-plated via. Advantageously, by providing the via as un-plated, reflections from sidewalls of the aperture may be reduced, thereby resulting in more coherent radiation propagating through the aperture.

The electro-acoustic transducer may comprise a plurality of lasers configured to emit radiation toward the membrane for sensing an excursion or velocity of the membrane.

Advantageously, provision of a plurality of lasers may enable more accurate detection and measurement of deformation, tilting or tipping of the membrane than would be achievable with a single laser.

For example, in use an electro-acoustic transducer operating as a loudspeaker may produce an audio signal with distortion for several reasons. Such distortion may result from deformations of the membrane and/or from changes in the orientation of the membrane, such as tilting of the membrane. The provision of a plurality of lasers as described above may enable monitoring of such undesired changes of the membrane, in real time, at a multiple locations of the membrane.

The provision of a plurality of lasers may enable accurate measurements of displacement and velocity of the membrane during operation of the electro-acoustic device, Furthermore, the plurality of lasers may also enable monitoring of a static position of the membrane, e.g. during start-up of a device comprising the electro-acoustic transducer.

Advantageously, based on the more accurate sensing that may be achieved with a plurality of lasers, actions may be taken to improve a performance of the electro-acoustic transducer. For example, an amplitude of a signal sent to the electro-acoustic transducer operating as a loudspeaker may be reduced to provide an undistorted or less distorted audio signal.

That is, by sensing the membrane at a plurality of locations, a shape and/or orientation of the membrane may be more closely monitored than by sensing the membrane at a single location.

In some embodiments, the plurality of lasers may be integrated into a single device, e.g. provided as a monolithic device. The plurality of lasers may be arranged in a grid or array.

Advantageously, this may provide a cost-efficient means to monitor the membrane.

The electro-acoustic transducer may comprise one or more radiation-sensitive devices configured to sense radiation reflected from the membrane, for sensing an excursion or velocity of the membrane.

In some embodiments, the plurality of radiation-sensitive devices may comprise sensors configured to sense an excursion or velocity of the membrane using at least two different wavelengths of radiation, e.g. implementing radiation sources configured to emit light of different wavelengths. Advantageously, in the case of membrane excursion or velocity sensing based on the self-mixing interference effect as described above, a relatively small difference in wavelength, such as 1 nm, 0.1 nm, or even less, may be sufficient to avoid cross-talk from one sensor to another which might otherwise disturb the measurements. Advantageously, in some cases even differences in wavelengths due to manufacturing tolerances may be sufficient to mitigate the effects of such crosstalk.

The plurality of laser and/or radiation-sensitive devices may be coupled to the substrate by soldering, or by means of a conductive connector, or the like.

According to a second aspect of the disclosure, there is provided a method of operating the electro-acoustic transducer of the first aspect. The method comprises: sensing a signal corresponding to a self-mixing interference effect, wherein the effect corresponds to an excursion or velocity of a membrane of the electro-acoustic transducer; and modifying a control signal for the electro-acoustic transducer in dependence of the sensed signal.

According to a third aspect of the disclosure, there is provided a communications device comprising the electro-acoustic transducer of the first aspect.

The communications device may, for example, be a mobile phone, a smart phone, a tablet device, a personal computer, a wearable device.

According to a fourth aspect of the disclosure, there is provided a method of assembling an electro-acoustic transducer, the method comprising: providing a membrane and at least one laser; configuring the at least one laser to emit radiation toward the membrane such that, in use, radiation emitted by the at least one laser is reflected from the membrane back toward the at least one laser produces a self-mixing interference effect corresponding to an excursion or velocity of the membrane.

The step of providing a membrane and at least one laser may also comprise providing a magnet and a coil coupled to the membrane and configured for movement relative to the magnet.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE PREFERRED EMBODIMENTS

These and other aspects of the present disclosure will now be described, by way of example only, with reference to the accompanying drawings, wherein:

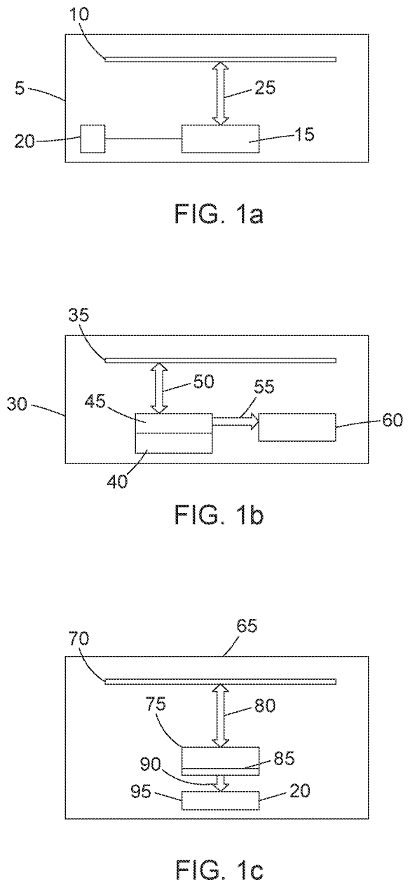

FIG. 1a depicts an electro-acoustic transducer comprising a membrane and a laser according to an embodiment of the disclosure

FIG. 1b depicts an electro-acoustic transducer comprising a membrane and a laser according to a further embodiment of the disclosure

FIG. 1c depicts an electro-acoustic transducer comprising a membrane and a laser according to a further embodiment of the disclosure

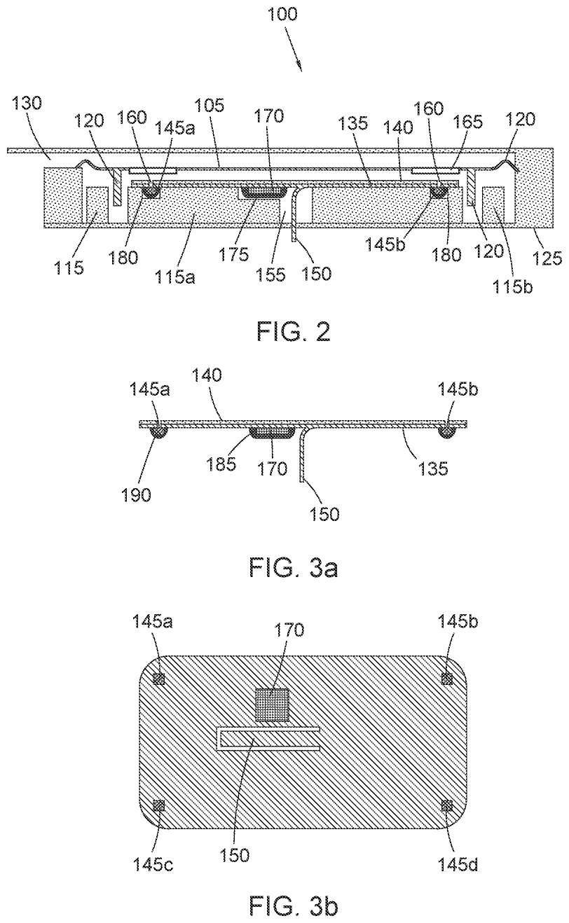

FIG. 2 depicts a cross-sectional view of an electro-acoustic transducer according to a further embodiment of the disclosure;

FIG. 3a depicts a cross-sectional view of a component of the electro-acoustic transducer of FIG. 2;

FIG. 3b depicts a bottom view of a component of the electro-acoustic transducer of FIG. 2;

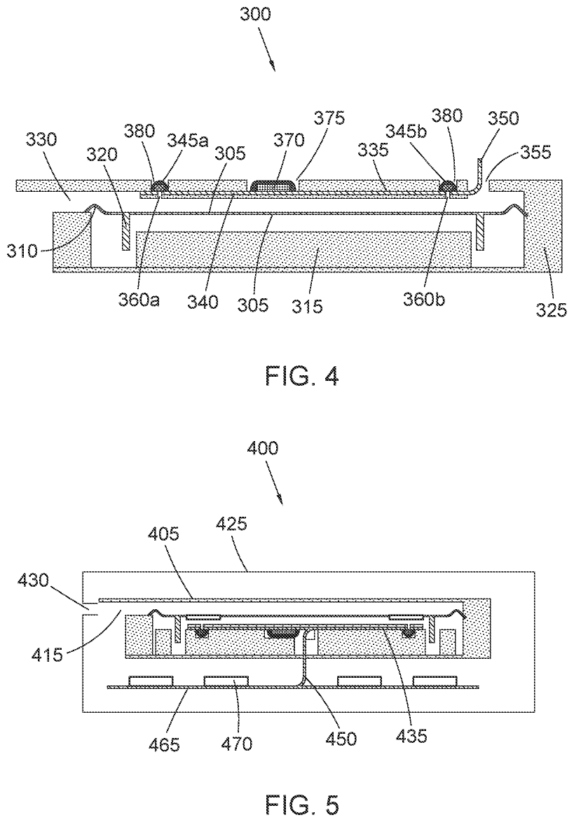

FIG. 4 depicts a cross-sectional view of an electro-acoustic transducer according to a further embodiment of the disclosure;

FIG. 5 depicts a communications device according to an embodiment of the disclosure;

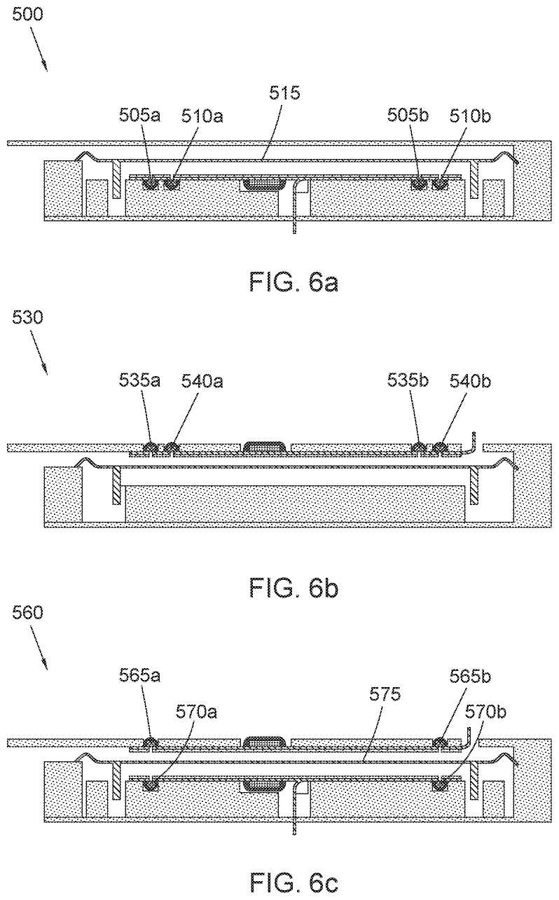

FIG. 6a depicts a cross-sectional view of an electro-acoustic transducer according to an embodiments of the disclosure;

FIG. 6b depicts a cross-sectional view of an electro-acoustic transducer according to a further embodiment of the disclosure;

FIG. 6c depicts a cross-sectional view of electro-acoustic transducer according to a further embodiment of the disclosure;

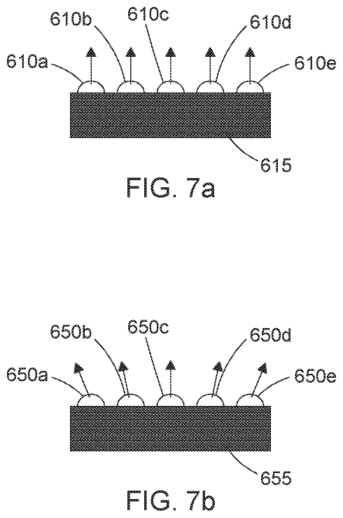

FIG. 7a depicts an arrangement of optical devices for use in an electro-acoustic transducer according to an embodiment of the disclosure;

FIG. 7b depicts a further arrangement of optical devices for use in an electro-acoustic transducer according to an embodiment of the disclosure;

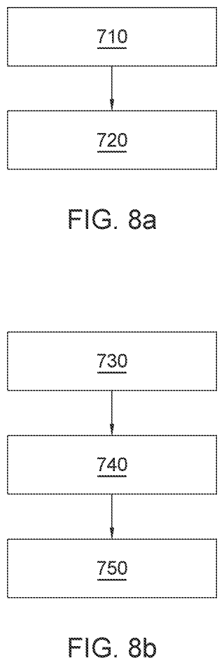

FIG. 8a depicts an method of assembling an electro-acoustic transducer according to an embodiment of the disclosure; and

FIG. 8b depicts a further method of assembling an electro-acoustic transducer according to an embodiment of the disclosure.

### DETAILED DESCRIPTION OF THE PREFERRED EMBODIMENTS

FIG. 1a depicts an electro-acoustic transducer 5 comprising a membrane 10 and a laser 15 according to an embodiment of the disclosure. The electro-acoustic transducer 5 also comprises circuitry 20. In one embodiment, the circuitry 5 is configured to drive the laser 15 with a constant current. The laser 5 emits radiation 25 toward the membrane 10, and at least a portion of the radiation 5 is reflected by the membrane 10 back toward the laser 15 to produce a self-mixing interference effect corresponding to an excursion or velocity of the membrane 10. The circuitry 5 is configured to measure a change in a junction voltage of the laser 15 corresponding to the self-mixing interference effect.

In another embodiment, the circuitry 5 is configured to drive the laser 15 with a constant junction voltage, and to measure a change in current through the laser 15 corresponding to the self-mixing interference effect.

FIG. 1b depicts an electro-acoustic transducer 30 comprising a membrane 35 and a laser 40 according to a further embodiment of the disclosure. The electro-acoustic transducer 30 comprises a beam-splitter 45 configured to direct a first portion 50 of radiation emitted by the laser 40 toward the membrane 35, and a second portion 55 of radiation emitted by the laser 40 toward a photodetector 60, for optically sensing a self-mixing interference effect.

In the example of FIG. 1b, the beam splitter 45 directs the second portion 55 of the radiation directly toward to the photodetector 60. In other embodiments, the beam splitter 45 may direct the second portion 55 of the radiation toward to the photodetector 60 by reflection off the membrane 35.

FIG. 1c depicts an electro-acoustic transducer 65 comprising a membrane 70 and a laser 75 according to a further embodiment of the disclosure.

The laser 75 emits a first portion 80 of radiation toward the membrane 70, and at least a portion of the radiation is reflected by the membrane 70 back toward the laser 75 to produce a self-mixing interference effect corresponding to an excursion or velocity of the membrane 70. A mirror 85 of a resonator in the laser 75 is partially transparent to enable a second portion 90 radiation emitted by the laser 75 to be incident on a photodetector 95, for optically sensing the self-mixing interference effect.

In some embodiments, the laser 75 is stacked on the photodetector 95.

FIG. 2 depicts a cross-sectional view of an electro-acoustic transducer 100 according to a further embodiment of the disclosure. The electro-acoustic transducer 100 is configured as a loudspeaker.

The electro-acoustic transducer 100 comprises a membrane 105. The membrane 105 comprises a film, and forms a diaphragm. In some embodiments, the membrane 105 may comprise a stretched film provided under tension. In an example embodiment, the membrane 105 may have a thickness in the region of 100 micrometers.

In the example embodiment of FIG. 2, a central portion of the membrane 105 is substantially flat in an initial, non-deformed state, e.g. where no electrical signal is applied to the electro-acoustic transducer 100. In other embodiments of the disclosure, the membrane 105 may be curved, or conical.

In the example embodiment of FIG. 2, a perimeter portion of the membrane 105 comprises a ridge 110. The ridge 110 is configured to flex in use, thereby facilitating a piston-type movement of the central portion of the membrane 105. While the ridge is depicted as convex relative to an upper surface of membrane 105, in other embodiments the ridge 110 may be concave relative to the upper surface of the membrane 105.

Also depicted is a magnet 115. The magnet 115 is a permanent magnet. In some embodiments, the magnet 115 may be a Neodymium magnet. In the example embodiment of FIG. 2, the magnet 115 comprises various recesses and an aperture, which are described in further detail below.

A coil 120, e.g. a conductive coil, is positioned around a main portion 115a of the magnet 115, within a recess 125 between the main portion 115a of the permanent magnet 115 and an outer portion 115b of the magnet.

In other embodiments falling within the scope of the disclosure, and for example as depicted in the embodiment of FIG. 4 described below, the coil 120 may be positioned around an outside of the magnet 115.

The coil 120 is coupled to the membrane 105, generally close to a perimeter portion of the membrane 105. In some embodiments, the coil 120 may be adhered to the membrane using an adhesive. In some embodiments, the coil 120 may be fused with, or otherwise mechanically coupled to, the membrane 105. In some embodiments, the coil 120 may be provided on a bobbin (not shown). As such, in operation an electrical signal corresponding to an audio signal may be supplied to the coil 120 causing the coil 120 to oscillate within a magnetic field of the magnet 115, thus leading to a sound pressure wave produced by the movement of the membrane 105 relative to the magnet 115.

The membrane 105, coil 120 and magnet 115 are provided in a casing or housing 125. The housing 125 has an outlet 130, enabling propagation of sound waves generated by vibration of the membrane 105 to exit the electro-acoustic transducer 100.

Also depicted in FIG. 2 is a substrate, which is a printed circuit board 135. In the example of FIG. 2, the printed circuit board 135 is a flex-printed circuit board, e.g., formed from a relatively flexible substrate. The printed circuit board 135 is disposed between the magnet 115 and the membrane 105. In some embodiments, the printed circuit board 135 may be adhered to the magnet 115.

The electro-acoustic transducer 100 also comprises a planar substrate 140 coupled to the printed circuit board 135, such that the printed circuit board 135 is disposed between the planar substrate 140 and the magnet 115. The planar substrate 140 may be rigid relative to the flex-printed circuit board. That is, the planar substrate 140 is configured to function as a stiffener, thereby providing support to the printed circuit board 135.

A plurality of lasers 145a, 145b, 145c, 145d are coupled to the printed circuit board 135. The lasers 145a, 145b, 145c, 145d may be coupled to the printed circuit board 135 by soldering, or by means of a conductive connector, or the like.

While only two lasers 145a, 145b are depicted in the cross-section of FIG. 2, it will be appreciated that in other embodiments of the disclosure only a single lasers, or greater than 2 lasers may be implemented. For example, as depicted in the bottom view of FIG. 2b, the example electro-acoustic transducer comprises four lasers 145a, 145b, 145c, 145d.

The lasers 145a, 145b, 145c, 145d are disposed on an opposite side of the printed circuit board 135 to the membrane 105.

The lasers 145a, 145b, 145c, 145d are provided for sensing an excursion or velocity of the membrane 105. Advantageously, by disposing the lasers 145a, 145b, 145c, 145d on an opposite side of the printed circuit board 135 to the membrane 105, functionality such as membrane 105 excursion sensing may be more easily implemented without substantially increasing an overall size of the electro-acoustic transducer 100.

The printed circuit board 135 comprises a plurality of apertures 160a, 160b for radiation from the lasers 145a, 145b, 145c, 145d to propagate through the printed circuit board 135.

That is, the lasers 145a, 145b, 145c, 145d are coupled to the printed circuit board 135 such that a radiation-emitting surface of the lasers 145a, 145b, 145c, 145d is directed toward the printed circuit board 135, and wherein the apertures 160a, 160b are aligned with the radiation-emitting surface. As such, radiation emitted from the radiation-emitting surface of the lasers 145a, 145b, 145c, 145d may propagate through the apertures 160a, 160b towards the membrane 105.

In some embodiments, the apertures 160a, 160b are formed from un-plated vias. Advantageously, by having the vias un-plated, reflections from sidewalls of the apertures 160a, 160b may be reduced, thereby resulting in more coherent radiation propagating through the apertures 160a, 160b.

In other embodiments, the at least a portion of the printed circuit board 135 may be transparent to radiation emitted by the lasers 145a, 145b, 145c, 145d, thereby mitigating a requirement for forming apertures 160a, 160b in the printed circuit board 135.

The planar substrate 140 also has apertures aligned with the apertures 160a, 160b in the printed circuit board 135.

The magnet 115 is provided with a recess 180 for locating the lasers 145a, 145b, 145c, 145d.

A conductive element 150 extends through an aperture 155 in the magnet 115 to provide an electrical connection to the printed circuit board 135. By providing the conductive element 150 extending through the aperture 155 in the magnet 115 to provide an electrical connection to the printed circuit board 135, substantial space may be saved by mitigating a requirement to find an alternative conductive path to the printed circuit board 135, or by mitigating a requirement to locate the printed circuit board 135 at a different location within the electro-acoustic transducer 100.

In some embodiments, the conductive element 150 may be coupled to the printed circuit board 135 by means of a connector, or the like. In other embodiments, and as described below with reference to FIG. 3b, the printed circuit board 135 and the conductive element 150 may be provided as a unitary member.

In the example embodiment of FIG. 2, the lasers 145a, 145b, 145c, 145d configured to emit radiation toward the membrane 105, such that radiation emitted by the lasers 145a, 145b, 145c, 145d is reflected from the membrane 105 back toward the lasers 145a, 145b, 145c, 145d to produce a self-mixing interference effect corresponding to an excursion or velocity of the membrane 105.

As described above, use of self-mixing interference to measure an excursion or velocity of the membrane 105 may provide extremely precise results. Furthermore, use of self-mixing interference may enable absolute distance measurements, thereby facilitating gauging and providing a more reliable operation of the electro-acoustic transducer 100.

In some embodiments, the self-mixing interference may be optically detected. For example, in some embodiments, at least one photodetector may be provided to detect radiation emitted by the laser and/or reflected from the membrane, as described above with reference to FIGS. 1a to 1c. In some embodiments the electro-acoustic transducer 100 may comprising a beam-splitter configured to direct a portion of radiation emitted by the lasers 145a, 145b, 145c, 145d to one or more photodetectors, for optically sensing the self-mixing interference effect, e.g. in an arrangement as depicted in FIG. 1b.

In yet further embodiments, a mirror of a resonator of at least one of the lasers 145a, 145b, 145c, 145d is partially transparent to enable radiation emitted by the at least one laser to be incident on a photodetector, for optically sensing the self-mixing interference effect, e.g. in an arrangement as depicted in FIG. 1c.

In some embodiments, the self-mixing interference may be electrically detected. For example, the electro-acoustic transducer 100 may comprise or be coupled to circuitry configured to drive at least one of the lasers 145a, 145b, 145c, 145d with a constant current, and to measure a change in a junction voltage of the laser(s) 145a, 145b, 145c, 145d corresponding to the self-mixing interference effect due to radiation reflected from the membrane 105. In other embodiments, the circuitry may be configured to drive the laser(s) 145a, 145b, 145c, 145d with a constant junction voltage, and to measure a change in current through the laser(s) 145a, 145b, 145c, 145d corresponding to the self-mixing interference effect, e.g. in an arrangement as depicted in FIG. 1a.

In some embodiments, the membrane 105 may comprise a reflector 165 or reflective coating for reflecting radiation emitted by the lasers 145a, 145b, 145c, 145d. In the example embodiment of FIG. 2, the reflector is disposed on a surface of the membrane 105 that is opposing the radiation-emitting surface of the lasers 145a, 145b, 145c, 145d. In other embodiments, the reflector 165 may be disposed on an outer surface of the membrane 105, e.g. an opposite surface of the membrane 105 to the surface of the membrane 105 that is opposing the radiation-emitting surface of the lasers 145a, 145b, 145c, 145d. In such embodiments, the membrane 105 may be substantially transparent to radiation emitted by the lasers 145a, 145b, 145c, 145d.

Also depicted in the example embodiment of FIG. 2 is an integrated circuit 170 coupled to the printed circuit board 135. The magnet 115 is provided with a recess 175 for locating the integrated circuit 170.

In the example of FIG. 2, the integrated circuit 170 is provided with a protective glob-top coating 185. Furthermore, for purposes of example, the lasers 145a, 145b, 145c, 145d are also depicted with a protective glob-top coating 190. In other embodiments, the integrated circuit 170 may be provided as a packaged device, e.g. in a surface mount package, a flat package, a chip-scale package, a ball-grid array or the like. The integrated circuit 170 may, for example be an ASIC. In some embodiments, the integrated circuit 170 comprises driver circuitry for driving the lasers 145a, 145b, 145c, 145d. In some embodiments, the integrated circuit 170 comprises sensing circuitry for sensing a signal from the lasers 145a, 145b, 145c, 145d. In some embodiments, the integrated circuit 170 comprises processing circuitry for processing and/or storing data corresponding to a signal from the optical devices 145a, 145b, 145c, 145d.

In other embodiments of the disclosure, necessary circuitry for driving and/or sensing a signal from the lasers and/or processing the signal may be provided on a further printed circuit board, wherein the printed circuit board 135 may be conductively coupled to the further printed circuit board by the conductive element 150.

FIG. 3a depicts a cross-sectional view of the printed circuit board 135 coupled to a planar substrate 140, with the integrated circuit 170 and lasers 145a, 145b coupled to the printed circuit board 135. FIG. 3b depicts a bottom view the printed circuit board 135 of FIG. 3a, showing an example arrangement of four lasers 145a, 145b, 145c, 145d. Advantageously, provision of a plurality of lasers 145a, 145b, 145c, 145d, in particular when spaced out around the periphery of the membrane 105 as shown in FIG. 3b, may enable more accurate detection and measurement of deformation, tilting or tipping of the membrane 105 than would be achievable with a single lasers.

Also shown in FIG. 3b is the conductive element 150, which is formed as a unitary member with the printed circuit board 135. That is, in the example embodiment of FIG. 3b, the printed circuit board 135 is a flex printed circuit board 135, and the conductive element 150 is formed as tongue of the printed circuit board 135 that, during assembly of a device implementing the electro-acoustic transducer 100, may be bent out of plane with the printed circuit board 135 to provide an electrical connection to a further device or further printed circuit board.

FIG. 4 depicts a cross-sectional view of an electro-acoustic transducer 300 according to a further embodiment of the disclosure. The electro-acoustic transducer 300 is configured as a loudspeaker.

The electro-acoustic transducer 300 comprises a membrane 305. The membrane 305 comprises a film, and forms a diaphragm. In some embodiments, the membrane 305 may comprise a stretched film provided under tension. In an example embodiment, the membrane 305 may have a thickness in the region of 100 micrometers.

In the example embodiment of FIG. 4, a central portion of the membrane 305 is substantially flat in an initial, non-deformed state, e.g. where no electrical signal is applied to the electro-acoustic transducer 300. In other embodiments of the disclosure, the membrane 305 may be curved, or conical.

In the example embodiment of FIG. 4, a perimeter portion of the membrane 305 comprises a ridge 310. The ridge 310 is for the same purposes as the ridge 110 of FIG. 2, and therefore is not described further. Also depicted is a permanent magnet 315. A coil 320, e.g. a conductive coil, is positioned around an outside of the magnet 315.

The coil 320 is coupled to the membrane 305 as described above with reference to the coil 120 and membrane 105 of FIG. 2. Similarly, operation of the coil 320 and membrane 305 is as described above with reference to FIG. 2.

The membrane 305, coil 320 and magnet 315 are provided in a housing 325. The housing 325 has an outlet 330, enabling propagation of sound waves generated by vibration of the membrane 305 to exit the electro-acoustic transducer 300.

Also depicted in FIG. 4 is a printed circuit board 335. In the example of FIG. 4, the printed circuit board 335 is a flex-printed circuit board, e.g., formed from a relatively flexible substrate. The membrane 305 is disposed between the printed circuit board 335 and the magnet 315. As such, unlike the example of FIG. 2, in the example embodiment of FIG. 4 the magnet 320 does not comprise an aperture or any recesses to house components of the printed circuit board 335.

The electro-acoustic transducer 300 also comprises a planar substrate 340 coupled to the printed circuit board 335, such that the printed circuit board 335 is disposed between the planar substrate 340 and the housing 325. The planar substrate 340 may be rigid relative to the printed circuit board 335. That is, the planar substrate 340 is configured to function as a stiffener, thereby providing support to the printed circuit board 335. In other embodiments, the printed circuit board 335 may be directly adhered to the housing 325, thereby mitigating a requirement for the planar substrate 340.

A plurality of lasers 345a, 345b are coupled to the printed circuit board 335. The lasers 345a, 345b may be coupled to the printed circuit board 335 by soldering, or by means of a conductive connector, or the like.

While in cross section only two lasers 345a, 345b are depicted in FIG. 4, it will be appreciated that in other embodiments of the disclosure only a single lasers, or greater than two lasers may be implemented. For example, as depicted in the bottom view of FIG. 3b, the example electro-acoustic transducer comprises four lasers 145a, 145b, 145c, 145d.

The lasers 345a, 345b are disposed on an opposite side of the printed circuit board 335 to the membrane 305. Similar to the embodiment of FIG. 2, the lasers 345a, 345b are provided for sensing an excursion or velocity of the membrane 305.

The printed circuit board 335 comprises a plurality of apertures 360a, 360b for radiation from the lasers 345a, 345b to propagate through the printed circuit board 335.

That is, the lasers 345a, 345b are coupled to the printed circuit board 335 such that a radiation-emitting surface of the lasers 345a, 345b is directed toward the printed circuit board 335, and wherein the apertures 360a, 360b are aligned with the radiation-emitting surface. As such, radiation emitted from the radiation-emitting surface of the lasers 345a, 345b may propagate through the apertures 360a, 360b towards the membrane 305. In some embodiments, the apertures 360a, 360b are formed from un-plated vias.

In embodiments comprising the planar substrate 340, the planar substrate 340 also has apertures aligned with the apertures 360a, 360b in the printed circuit board 335.

The housing 325 is provided with recesses 380 for locating the optical devices 345a, 345b.

In the example of FIG. 4, a conductive element 350 extends through an aperture 355 in the housing 325 to provide an electrical connection to the printed circuit board 335.

In some embodiments, the conductive element 350 may be coupled to the printed circuit board 335 by means of a connector, or the like. In other embodiments, and as described above with reference to FIG. 3b, the printed circuit board 335 and the conductive element 350 may be provided as a unitary member.

Similar to the embodiment of FIG. 2, in the example embodiment of FIG. 4 the lasers 345a, 345b configured to emit radiation toward the membrane 305, such that radiation emitted by the lasers 345a, 345b is reflected from the membrane 305 back toward the lasers to produce a self-mixing interference effect corresponding to an excursion or velocity of the membrane 305.

Similar to the embodiment of FIG. 2, in some embodiments the membrane 305 may comprise a reflector or a reflective coating for reflecting radiation emitted by the optical devices 345a, 345b Also depicted in the example embodiment of FIG. 4 is an integrated circuit 370 coupled to the printed circuit board 335. The housing 325 is provided with a recess 375 for locating the integrated circuit 370. The integrated circuit 370 may have features in common with that of the integrated circuit 170 of FIG. 2, and therefore is not describe in further detail.

FIG. 5 depicts a communications device 400 according to an embodiment of the disclosure. The communications device 400 comprises an electroacoustic transducer 405, which may be an electrostatic transducer 100 as depicted in FIG. 2. In other embodiments falling within the scope of the disclosure, the communications device 400 may comprise an electro-acoustic transducer 300 as depicted in FIG. 4.

The communications device 400 may be, for example, a mobile phone, a smart phone, a tablet device, a personal computer, a wearable device, or the like.

The communications device 400 comprises a housing 425 within which the electro-acoustic transducer 100 is disposed. The housing 425 has an outlet 430. The outlet is aligned with, or coupled to, an outlet 415 in the electro-acoustic transducer 405.

The conductive element 450 couples a printed circuit board 435 of the electro-acoustic transducer to a further printed circuit board 465.

In some embodiments, the printed circuit board 435 may be coupled to the further printed circuit board 465 by means of a connector. In some embodiments wherein the printed circuit board 435 is provided as a flex printed circuit board, the printed circuit board 435 may be coupled to the further printed circuit board 465 by means of a ‘hot-bar’ process. In an example, the hot-bar process may comprise pre-coating the conductive element 450 and the further printed circuit board 465 with solder, and then heating the conductive element 450 and the further printed circuit board 465 and pressing them together to form a permanent conductive bond.

In the example of FIG. 5, the further printed circuit board 465 is provided with further integrated circuits 470, which may be for providing functionality of the communications device, and for providing a signal to and/or sensing a signal from the electro-acoustic transducer 100.

FIGS. 6a, 6b and 6c depict cross-sectional views of example electro-acoustic transducers according to further embodiments of the disclosure, and depicting different configurations of optical devices.

For example, FIG. 6a depicts an electro-acoustic transducer 500 generally structurally comparable to the electro-acoustic transducer 100 of FIG. 2. In the example of FIG. 6a, the optical devices comprise lasers 505a, 505b and radiation-sensitive devices 510a, 510b, e.g. photodetectors. While the example embodiment of FIG. 6a depicts a total of four optical devices arranged as two pairs, it will be appreciated that in other embodiments fewer or greater than two pairs of optical devices may be implemented.

The lasers 505a, 505b are configured to emit radiation towards a membrane 515 of the electro-acoustic transducer 500. At least a portion of radiation emitted by the lasers 505a, 505b is reflected back into the radiation-emitting devices 505a, 505b, thereby causing a self-mixing interference effect. The self-mixing interference effect be optically detected by the radiation-sensitive devices 510a, 510b.

FIG. 6b depicts a further example of an electro-acoustic transducer 530 generally structurally comparable to that of FIG. 3. In the example of FIG. 6b, the optical devices comprise lasers 535a, 535b and radiation-sensitive devices 540a, 540b. While the example embodiment of FIG. 6b depicts a total of four optical devices arranged as two pairs, it will be appreciated that in other embodiments fewer or greater than two pairs of optical devices may be implemented. Operation of the lasers 535a, 535b and radiation-sensitive devices 540a, 540b is the same as that of FIG. 6a, and therefore is not described in further detail.

FIG. 6c depicts a further example of an electro-acoustic transducer 560 generally structurally comparable to that of FIGS. 2 and 3, e.g. having two printed circuit boards with optical devices coupled to the printed circuit boards. A first printed circuit board is disposed between the magnet and the membrane, and the second printed circuit board is disposed between the membrane and a housing of the electro-acoustic transducer.

In the example of FIG. 6c, the optical devices comprise lasers 565a, 565b and radiation-sensitive devices 570a, 570b. While the example embodiment of FIG. 6c depicts a total of four optical devices arranged as two pairs, it will be appreciated that in other embodiments fewer or greater than two pairs of optical devices may be implemented.

The lasers 565a, 565b may, for example, be laser diodes. In some embodiments, the lasers 565a, 565b are VCSELs. The lasers 565a, 565b are configured to emit radiation towards a membrane 575 of the electro-acoustic transducer 560.

The membrane 575 is partially transparent to the radiation emitted by the lasers 565a, 565b. As such, a portion of the radiation emitted by the lasers 565a, 565b is reflected from the membrane 575 back into the lasers 565a, 565b, causing a measureable self-interference effect that corresponds to a distance to the membrane 575.

A portion of the radiation emitted by the lasers 565a, 565b propagates though the membrane, and is detected by the radiation-sensitive devices 570a, 570b. The self-mixing interference effect may be optically detected by the radiation-sensitive devices 570a, 570b.

FIG. 7a depicts an arrangement of lasers 610a-e for use in an electro-acoustic transducer. It will be understood that the lasers 610a-e may correspond to the lasers of FIGS. 2 to 6, for use in an electro-acoustic transducer 100, 300, 500, 530, 560 as described above. In the example of FIG. 7a, several lasers 610a-610e are integrated on a single device 615, such as in form of a grid or array. Advantageously, such an arrangement provides cost-efficiency. In the example of FIG. 7a, all the lasers 610a-e emit radiation along substantially the same direction.

FIG. 7b depicts a further arrangement of lasers 650a-e integrated on a single device 665 for use in an electro-acoustic transducer according to an embodiment of the disclosure. In the example of FIG. 7a, at least some of the lasers 650a-e emit radiation along different directions.

An electro-acoustic transducer implemented using the arrangement of lasers of FIGS. 7a and/or 7b may be assembled such that all of the optical device 610a-e and/or 650a-e emit radiation through a single aperture in a printed circuit board, e.g. apertures 160a, 160b as depicted in FIG. 2 on printed circuit board 135.

FIG. 8a depicts a method of operating the electro-acoustic transducer described above. The method comprises a first step 710 of sensing a signal corresponding to a self-mixing interference effect, wherein the effect corresponds to an excursion or velocity of a membrane of the electro-acoustic transducer.

The method comprises also comprises a second step 720 of modifying a control signal for the electro-acoustic transducer in dependence of the sensed signal.

FIG. 8b depicts a method of assembling an electro-acoustic transducer according to an embodiment of the disclosure. A first step 730 comprises providing a membrane and at least one laser. The step 730 may also comprise providing a magnet and a coil coupled to the membrane and configured for movement relative to the magnet.

A second step 740 comprises configuring the at least one laser to emit radiation toward the membrane such that, in use, radiation emitted by the at least one laser is reflected from the membrane back toward the at least one laser produces a self-mixing interference effect corresponding to an excursion or velocity of the membrane.

It will be understood that the above description is merely provided by way of example, and that the present disclosure may include any feature or combination of features described herein either implicitly or explicitly of any generalization thereof, without limitation to the scope of any definitions set out above. It will further be understood that various modifications may be made within the scope of the disclosure.

LIST OF REFERENCE NUMERALS

| | |
|---|---|
| 5 | Electro-acoustic transducer |
| 10 | Membrane |
| 15 | Laser |
| 20 | Circuitry |
| 25 | Radiation |
| 30 | Electro-acoustic transducer |
| 35 | Membrane |
| 40 | Laser |
| 45 | Beam-splitter |
| 50 | First portion |
| 55 | Second portion |
| 60 | Photodetector |
| 65 | Electro-acoustic transducer |
| 70 | Membrane |
| 75 | Laser |
| 80 | First portion |
| 85 | Mirror |
| 90 | Second portion |
| 95 | Photodetector |
| 100 | Electro-acoustic transducer |
| 105 | Membrane |
| 110 | Ridge |
| 115 | Magnet |
| 115a | Main portion |
| 115b | Outer portion |
| 120 | Coil |
| 125 | Housing |
| 130 | Outlet |
| 135 | Printed Circuit Board |
| 140 | Planar substrate |
| 145a-d | lasers |
| 150 | Conductive element |
| 155 | Aperture |
| 160a-b | Apertures |
| 165 | Reflector |
| 170 | Integrated Circuit |
| 175 | Recess |
| 180 | Recess |
| 185 | Glob-top coating |
| 190 | Glob-top coating |
| 300 | Electro-acoustic transducer |
| 305 | Membrane |
| 310 | Ridge |
| 315 | Magnet |
| 320 | Coil |
| 325 | Housing |
| 330 | Outlet |
| 335 | Printed Circuit Board |
| 340 | Planer substrate |
| 345a-b | lasers |
| 350 | Conductive element |
| 355 | Aperture |
| 360a-b | Apertures |
| 370 | Integrated Circuit |
| 375 | Recess |
| 380 | Recess |
| 400 | Communications device |
| 405 | Electro-acoustic transducer |
| 415 | Outlet |
| 425 | Housing |
| 430 | Outlet |
| 435 | Printed circuit board |
| 450 | Conductive element |
| 465 | Further printed circuit board |
| 470 | Further integrated circuit |
| 500 | Electro-acoustic transducer |
| 505a-b | lasers |
| 510a-b | Radiation-sensitive devices |
| 515 | Membrane |
| 530 | Electro-acoustic transducer |
| 535a-b | Lasers |
| 540a-b | Radiation-sensitive devices |
| 560 | Electro-acoustic transducer |
| 565a-b | Lasers |
| 570a-b | Radiation-sensitive devices |
| 575 | Membrane |
| 610a-e | Lasers |
| 615 | Device |
| 650a-e | lasers |
| 665 | Device |
| 710 | First step |
| 720 | Second step |
| 730 | First step |
| 740 | Second step |
| 750 | Third step |

1. An electro-acoustic transducer comprising:
a membrane; and
at least one laser;
the at least one laser configured to emit radiation toward the membrane, such that radiation emitted by the at least one laser is reflected from the membrane back toward the at least one laser to produce a self-mixing interference effect corresponding to an excursion or velocity of the membrane.

2. The electro-acoustic transducer of claim 1, comprising a substrate and a magnet, wherein the at least one laser is coupled to the substrate and the substrate is provided between the magnet and the membrane.

3. The electro-acoustic transducer of claim 2 wherein a conductive element extends through an aperture in the magnet to provide an electrical connection to the substrate.

4. The electro-acoustic transducer of claim 2, wherein the at least one laser is disposed at an opposite side of the substrate to the membrane.

5. The electro-acoustic transducer of claim 2, wherein the substrate comprises at least one aperture for radiation from the at least one laser to propagate through the substrate.

6. The electro-acoustic transducer of claim 1, comprising a plurality of lasers configured to emit radiation toward the membrane for sensing an excursion or velocity of the membrane.

7. The electro-acoustic transducer of claim 1, wherein the at least one laser comprises a vertical cavity surface emitting laser.

8. The electro-acoustic transducer of claim 1, comprising a beam splitter configured to direct a portion of radiation emitted by the at least one laser to a photodetector, for optically sensing the self-mixing interference effect.

9. The electro-acoustic transducer of claim 1, wherein a mirror of a resonator in the at least one laser is partially transparent to enable radiation emitted by the at least one laser to be incident on a photodetector, for optically sensing the self mixing interference effect.

10. The electro-acoustic transducer of claim 1, comprising circuitry configured to drive the at least one laser with a constant current, and to measure a change in a junction voltage of the at least one laser corresponding to the self-mixing interference effect.

11. The electro-acoustic transducer of claim 1, comprising circuitry configured to drive the at least one laser with a constant junction voltage, and to measure a change in current through the at least one laser corresponding to the self-mixing interference effect.

12. The electro-acoustic transducer of claim 1, configured as a loudspeaker.

13. A method of operating the electro-acoustic transducer of claim 1, the method comprising:
sensing a signal corresponding to a self-mixing interference effect, wherein the effect corresponds to an excursion or velocity of a membrane the electro acoustic transducer; and
modifying a control signal for the electro-acoustic transducer in dependence of the sensed signal.

14. A communications device comprising the electro-acoustic transducer of claim 1.

15. A method of assembling an electro-acoustic transducer, the method comprising:
providing a membrane and at least one laser;
configuring the at least one laser to emit radiation toward the membrane such that, in use, radiation emitted by the at least one laser is reflected from the membrane back toward the at least one laser produces a self-mixing interference effect corresponding to an excursion or velocity of the membrane.
